(19) United States
(12) Patent Application Publication
(10) Pub. No.: US 2016/0028171 A1
(43) Pub. Date: Jan. 28, 2016

(54) ELECTRICAL CONNECTOR ASSEMBLY

(71) Applicants: LOTES CO., LTD, Keelung (TW); GIGA-BYTE TECHNOLOGY CO., LTD., New Taipei (TW)

(72) Inventors: Wen Chang Chang, Keelung (TW); Bin Wu He, Keelung (TW)

(21) Appl. No.: 14/495,358

(22) Filed: Sep. 24, 2014

(30) Foreign Application Priority Data
Jul. 22, 2014 (CN) 201420404612.2

(51) Int. Cl. H01R 12/70

(52) U.S. Cl. CPC H01R 12/7076

(57) ABSTRACT

An electrical connector assembly for connecting a chip module, includes an insulation body, multiple conducting terminals and a separation plate. The insulation body has a conducting area. Two opposite side walls extend upward from two opposite sides of the conducting area. The side walls have a positioning block protruded upward. The multiple conducting terminals are located in the conducting area and used for contacting the chip module. The separation plate is located above the conducting area and positioned by the positioning block. When the chip module is mounted downward into the insulation body, the chip module is located on the separation plate.

### CROSS-REFERENCE TO RELATED APPLICATION

This non-provisional application claims priority under 35 U.S.C. §119(a) on Patent Application No. 201420404612.2 filed in P.R. China on Jul. 22, 2014, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD OF THE INVENTION

The present invention relates to an electrical connector assembly, and in particular, to an electrical connector assembly that prevents damage to a conducting terminal.

### BACKGROUND OF THE INVENTION

At present, a land grid array (LGA) electrical connector is commonly used in the industry. The LGA electrical connector includes an insulation body, a conducting terminal disposed in the insulation body, a reinforcement piece disposed on a periphery of the insulation body, and a driving lever and a cover disposed at two opposite ends of the reinforcement piece. When a chip module is mounted, the cover and the driving lever need to be twisted and opened. Then the chip module is manually placed on the insulation body. At last, the cover and the driving lever are rotated and buckled, thereby implementing an electrical connection between the chip module and the conducting terminal in the insulation body. However, when the chip module is directly and manually mounted into the electrical connector, operation errors such as misaligning and using excessive strength may occur, which causes damage to the conducting terminal.

To solve the problem of causing damage to a conducting terminal, Chinese Patent No. CN201210314481.4 discloses an electrical connector assembly, including an insulation body 2, a conducting terminal 1 accommodated in the insulation body 2, and a guide plate 3 disposed on the insulation body 2. The guide plate 3 includes a guide frame 31 and a pulling plate 32 mounted on the guide frame 31. The guide frame 31 is provided with a frame body 310 abutting a side wall 20 of the insulation body 2. Slide tracks 313 are disposed on two opposite sides of the frame body 310. The pulling plate 32 includes a main body 320 and a pickup part 321. The main body 320 is inserted in the slide tracks 313, so that the pulling plate 32 is mounted on the guide frame 31 and covers the conducting terminal 1. When a chip module 4 is mounted into the electrical connector assembly, in a first step, the guide frame 31 and the pulling plate 32 of the guide plate 3 are assembled as a unity, and then the assembled guide plate 3 is mounted on the insulation body 2. In the second step, the chip module 4 is supported on the pulling plate 32. In the third step, the pickup part 321 is grasped with fingers, and then the pulling plate 32 is horizontally pulled out from a location between the guide frame 31 and the chip module 4. At this time, the chip module 4 falls freely. In the fourth step, the guide frame 31 is removed. The chip module 4 can be correctly mounted on the insulation body 2 by using the guide plate 3, thereby preventing operation errors occurred when the chip module 4 is directly and manually mounted. Further, the guide plate 3 is provided with the pulling plate 32, and the pulling plate 32 covers the conducting terminal 1, which can prevent exposure of the conducting terminal 1 before the chip module 4 is mounted on the insulation body 2. Therefore, the conducting terminal 1 can be kept free of pollution from dust, and accidental damage to the conducting terminal 1 can also be prevented.

However, because the pulling plate 32 is mounted on the guide frame 31, the guide frame 31 as an element needs to be added, which results in a complex structure and a high cost. Further, during mounting, it is required to assemble the pulling plate 32 with the guide frame 31 and then mount the guide frame 31 on the insulation body 2. The assembling and mounting process is complicated.

Therefore, a heretofore unaddressed need exists in the art to address the aforementioned deficiencies and inadequacies.

### SUMMARY OF THE INVENTION

In one aspect, the present invention is directed to an electrical connector assembly having a simple structure and a low cost.

In one embodiment, an electrical connector assembly includes an insulation body, multiple conducting terminals, and a separation plate. The insulation body has a conducting area. Two opposite side walls extend upward from two opposite sides of the conducting area. The side walls have a positioning block protruded upward. The multiple conducting terminals are located in the conducting area and used for contacting a chip module. The separation plate is located above the conducting area and positioned by the positioning block. When the chip module is mounted downward into the insulation body, the chip module is located on the separation plate.

In one embodiment, the separation plate is an insulating film having a flat plate shape.

In one embodiment, a clearance exists between the separation plate and the conducting terminal in a height direction.

In one embodiment, two positioning blocks are disposed at two opposite ends of the side wall to clamp the separation plate, and a support portion is disposed between the two positioning blocks on the side wall to support the separation plate.

In one embodiment, the height of the separation plate is less than the height of the positioning block, and the positioning block positions the chip module.

In one embodiment, the insulation body is provided with at least one positioning post for positioning the chip module, and the positioning post and the positioning block are located on different sides of the conducting area.

In one embodiment, an operating portion extending beyond the insulation body is disposed at each of two opposite ends of the separation plate, and a pre-broken portion is disposed in the middle of the separation plate. When the two operating portions are operated from two opposite directions, the separation plate is pulled apart at the pre-broken portion and is pulled away from the insulation body from two opposite directions.

In one embodiment, two separation plates are disposed and are located abreast above the conducting area, and the two separation plates are each provided with an operating portion. The two operating portions face different directions, so that the two separation plates are pulled away from the insulation body from two directions.

In one embodiment, the electrical connector assembly further includes a stiffener surrounding a periphery of the insulation body. The stiffener has a support portion. An extension portion extending from the separation plate and beyond the insulation body and is supported by the support portion.

In one embodiment, the support portion is lower than the side wall, the extension portion bends downward, and a clearance exists between the separation plate and the corresponding side wall in a height direction.

In one embodiment, the separation plate includes an operating portion extending outward beyond the insulation body and used for horizontally pulling the separation plate away from the insulation body. An end of the operating portion bends upward.

In the present invention, the separation plate is positioned by the positioning block of the insulation body, thereby omitting the guide frame described in the background of the invention. Therefore, compared with the related art, the present invention has a simple structure, a low cost, and is convenient to assemble.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 is a schematic three-dimensional view of a separation plate and an insulation body before mounting according to a first embodiment of the present invention.

FIG. 2 is a schematic three-dimensional view of the separation plate and the insulation body after mounting according to the first embodiment of the present invention.

FIG. 3 is a schematic three-dimensional view of a chip module and the insulation body after mounting according to the first embodiment of the present invention.

FIG. 4 is a schematic three-dimensional view of pulling the separation plate away from the insulation body according the first embodiment of the present invention.

FIG. 5 is a schematic sectional view of FIG. 3.

FIG. 6 is a schematic sectional view of FIG. 4.

FIG. 7 is a schematic three-dimensional view of a separation plate and an insulation body before mounting according to a second embodiment of the present invention.

FIG. 8 is a schematic sectional view of FIG. 7.

FIG. 9 is a schematic three-dimensional view of the separation plate and the insulation body after mounting according to the second embodiment of the present invention.

FIG. 10 is a schematic three-dimensional view of a separation plate and an insulation body after mounting according to a third embodiment of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

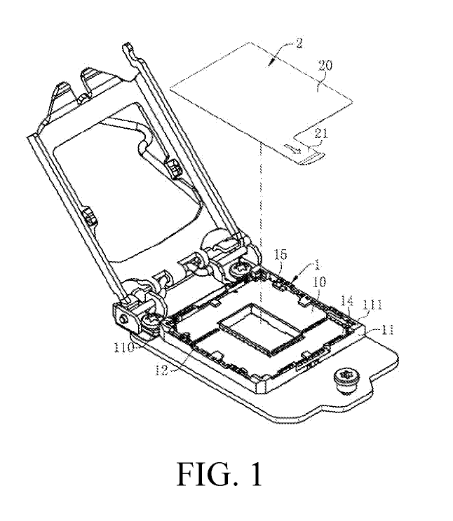

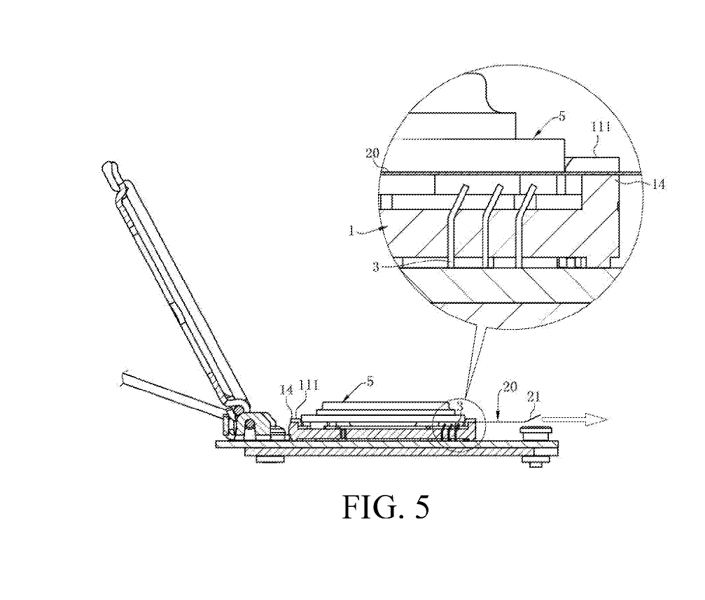

As shown in FIG. 1 and FIG. 5, in a first embodiment of the present invention, an electrical connector assembly is used for electrically connecting a chip module 5. The electrical connector assembly includes an insulation body 1, multiple conducting terminals 3, and a separation plate 2.

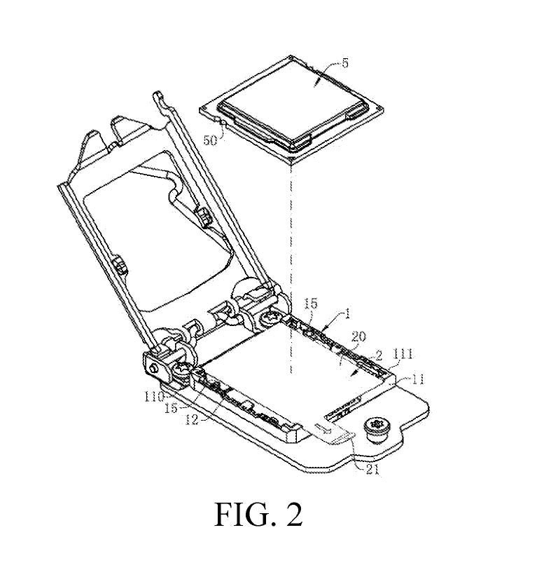

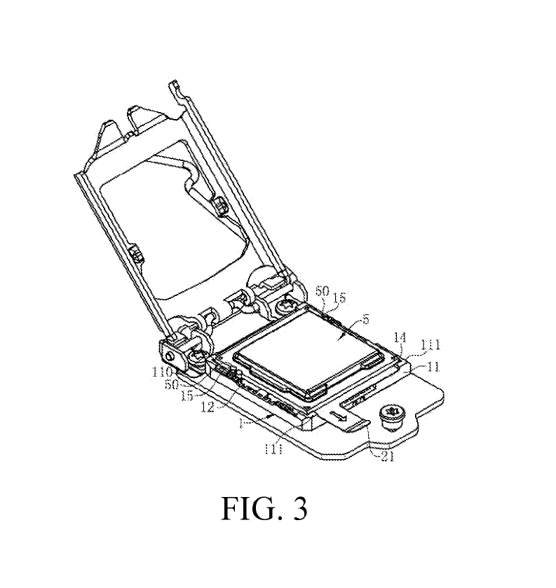

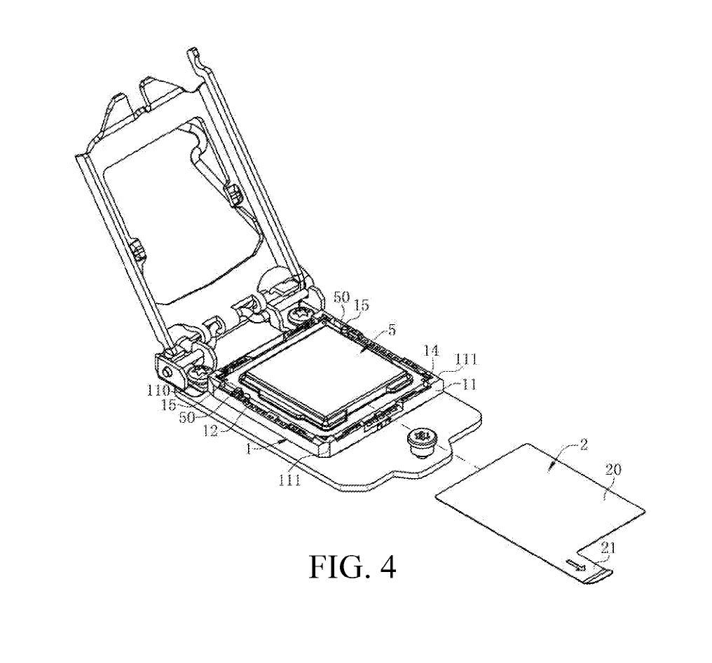

As shown in FIGS. 1-5, the insulation body 1 is substantially rectangular, and has a conducting area 10. The conducting terminals 3 are fixed in the conducting area 10, and used for contacting the chip module 5. Two opposite first side walls 11 are formed by extending upward from two opposite sides of the conducting area 10. Two second side walls 12 are formed by extending upward from the other two opposite sides of the conducting area 10. Two positioning blocks 111 (which can reinforce strength of the insulation body 1) protrude upward at two opposite ends of the first side wall 11, and are used for positioning the separation plate 2. In certain embodiments, the positioning blocks 111 may not be disposed at two opposite ends of the first side wall 11. In other embodiments, there may be one or more positioning blocks 111. A support portion 14 is disposed between the two positioning blocks 111 on the first side wall 11, and is used for supporting the separation plate 2. A height of the support portion 14 is greater than that of the conducting terminals 3. A stop block 110 is formed by protruding from the positioning block 111 towards the conducting area 10. The stop block 10 is used for positioning the chip module 5. A positioning post 15 is formed by protruding on each of the second side walls 12 towards the conducting area 10. The positioning posts 15 are used for cooperating with a groove 50 on the chip module 5, so as to position the chip module 5 in the conducting area 10. The positioning posts 15 and the positioning blocks 111 are located on different sides of the conducting area 10, so that the separation plate 2 covers a large range above the conducting terminals 3. In other embodiments, the positioning posts 15 and the positioning blocks 111 may be located on a same side of the conducting area 10.

As shown in FIGS. 1-4, the separation plate 2 is an insulating film having a flat plate shape. The insulating film is a mylar sheet, so that the separation plate 2 has a simple structure and a low cost. The separation plate 2 has certain softness, so that the conducting terminals 3 are not damaged easily when contacting the separation plate 2. In other embodiments, the separation plate 2 may not be an insulating film, and the separation plate 2 may also be made of metal. The separation plate 2 includes a main body portion 20, which has a flat plate shape and covers the conducting terminals 3. An operating portion 21 horizontally extends from the main body portion 20. The main body portion 20 is clamped between the two positioning blocks 111, so that the main body portion 20 is positioned by the positioning blocks 111. The main body portion 20 is supported by the support portion 14, and a clearance exists between the main body portion 20 and the conducting terminals 3 in a height direction, so that the separation plate 2 does not contact the conducting terminals 3. In this way, when the separation plate 2 is pulled out, the separation plate 2 does not rub against the conducting terminals 3. In other embodiments, the separation plate 2 may also contact the conducting terminals 3, or the separation plate 2 is supported by the conducting terminals 3. The height of the main body portion 20 is less than the height of the positioning blocks 111, so that the positioning blocks 111 can also position the chip module 5 while positioning the separation plate 2, thereby preventing the chip module 5 from moving relative to the insulation body 1 along with the separation plate 2 when the separation plate 2 is pulled away from the insulation body 1. The operating portion 21 extends outward beyond the insulation body 1, and is used for horizontally pulling the separation plate 2 away from the insulation body 1. An end of the operating portion 21 bends upward, so that a user can more conveniently pull the separation plate 2 away from the insulation body 1.

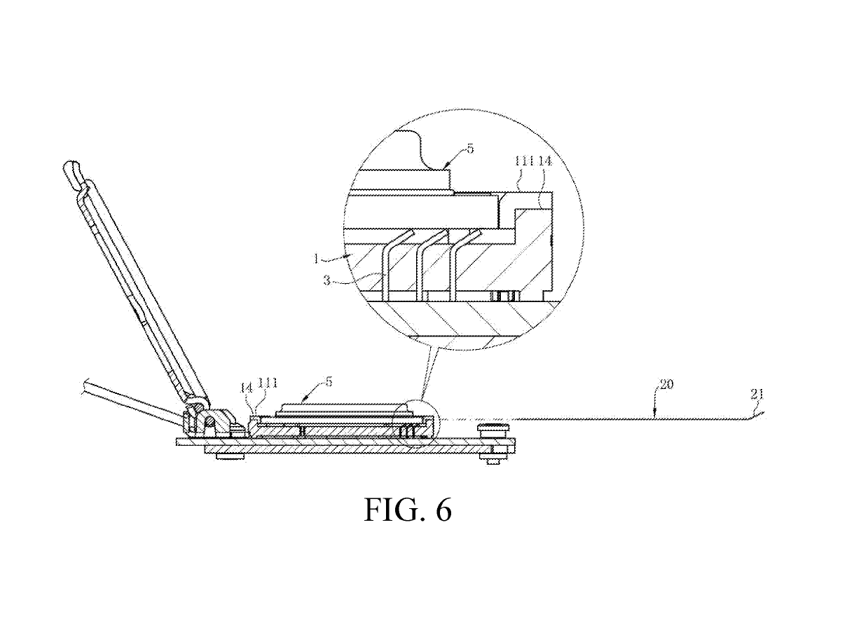

As shown in FIGS. 1-6, when the chip module 5 is mounted into the electrical connector assembly, in a first step, the separation plate 2 is mounted on the insulation body 1. In this embodiment, the main body portion 20 is positioned by the positioning blocks 111, and the main body portion 20 is supported by the support portion 14. In a second step, the chip module 5 is mounted on the separation plate 2. The chip module 5 is positioned by using the positioning blocks 111, and the main body portion 20 of the separation plate 2 supports the chip module 5. In a third step, the operating portion 21 is pulled, so as to horizontally pull out the separation plate 2 from a location between the insulation body 1 and the chip module 5. Then the chip module 5 falls freely and contacts the conducting terminals 3 in the conducting area 10.

By using the separation plate 2 in this embodiment, when the chip module 5 is mounted downward into the insulation body 1, the chip module 5 is first located on the separation plate 2, and then the separation plate 2 is pulled out so that the chip module 5 falls freely, thereby preventing damage to the conducting terminals 3 caused by an operation error occurring when the chip module 5 is directly and manually mounted.

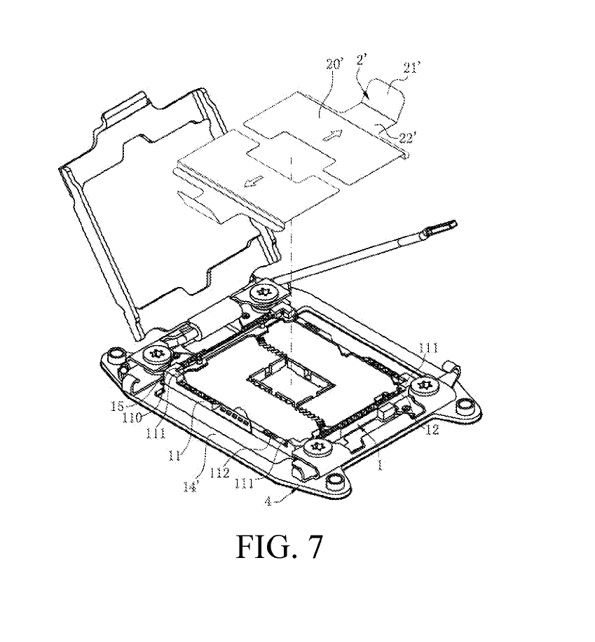

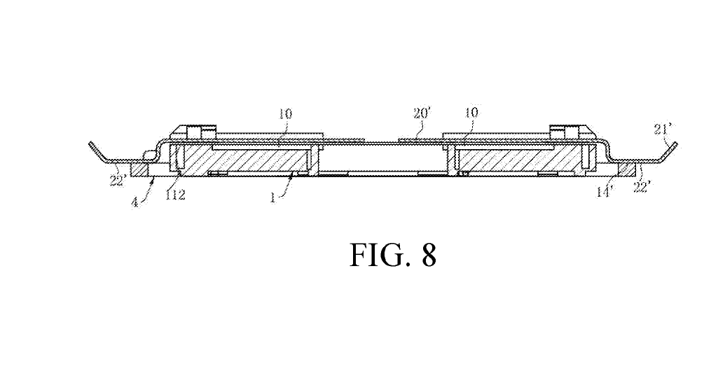

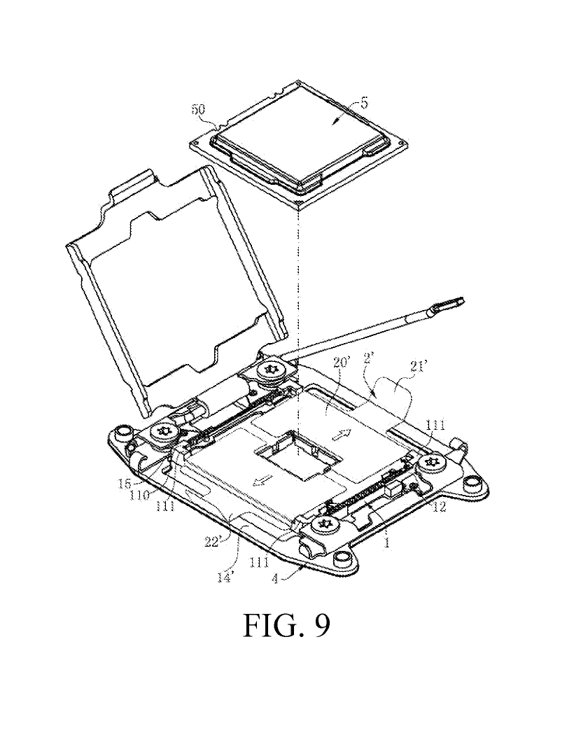

As shown in FIGS. 7-9, in a second embodiment of the present invention, differences between the second embodiment and the first embodiment lie in that: two separation plates 2′ are disposed, and are located symmetrically above the conducting area 10. The separation plate 2′ is provided with a main body portion 20′ clamped between the two positioning blocks 111. A concave portion 112 is formed between the two positioning blocks 111, and the height of the concave portion 112 is less than that of the conducting terminals 3. A clearance exists between the main body portion 20′ of the separation plate 2′ and the concave portion 112 in a height direction. That is, the clearance exists between the main body portion 20′ of the separation plate 2′ and the corresponding first side wall 11 in a height direction. An extension portion 22′, which extends from the main body portion 20′ and beyond the insulation body 1 and bends downward, is formed. An operating portion 21′ extends from the extension portion 22′, and is used for pulling the separation plate 2′ away from the insulation body 1. The operating portions 21′ of the two separation plates 2′ face different directions, so that the two separation plates 2′ are pulled away from the insulation body 1 from two directions. The electrical connector assembly further includes a stiffener 4. The stiffener 4 is substantially a rectangular frame body surrounding a periphery of the insulation body 1. The stiffener 4 has a support portion 14′ corresponding to each of the extension portions 22′ and glued to the extension portions 22′. The height of the support portions 14′ is less than the height of the first side wall 11. The support portions 14′ support the extension portions 22′. A clearance may also exist between the separation plate 2′ and the conducting terminals 3 in a height direction.

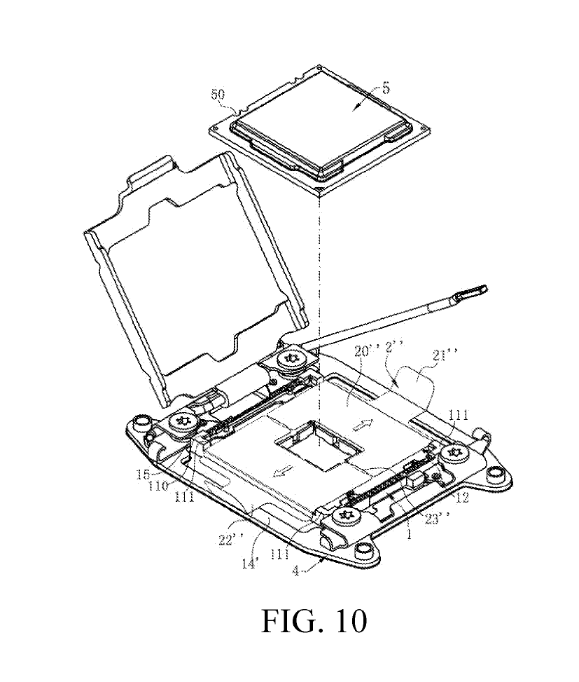

As shown in FIG. 10, differences between a third embodiment and the second embodiment lie in that: one separation plate 2″ is disposed, an operating portion 21″ extending beyond the insulation body 1 is disposed at each of two opposite ends of the separation plate 2′, and a pre-broken portion 23″ is disposed in the middle of the separation plate 2″. When the two operating portions 21″ are operated from two opposite directions, the separation plate 2″ is pulled apart at the pre-broken portion 23″ and is pulled away from the insulation body 1 from two opposite directions.

In summary, the electrical connector assembly in the present invention, among other things, has the following beneficial advantages.

(1) The separation plate 2 is positioned by the positioning blocks 111 of the insulation body 1. Therefore, no additional element needs to be added to position the separation plate 2, so that an electrical connector has a simple structure, a low cost, and is easy to be assembled.

(2) Compared with pulling out the separation plate 2 from only one direction, pulling the separation plate 2 away from the insulation body 1 from two directions can reduce a distance for which the separation plate 2 slides on the insulation body 1.

(3) The height of the separation plate 2 is less than the height of the positioning block 111, so that the positioning block 111 can position the chip module 5. In this way, when the separation plate 2 is pulled out from a location between the chip module 5 and the insulation body 1, the chip module 5 does not move relative to the insulation body 1. Besides, because the separation plate 2 is positioned by using the positioning blocks 111 for positioning the chip module 5, no additional structure needs to be disposed on the insulation body 1 to position the separation plate 2, thereby achieving effects of simple structure and low cost.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector assembly for connecting a chip module, comprising:
an insulation body, having a conducting area and two opposite side walls extending upward from two opposite sides of the conducting area, wherein the side walls have a positioning block protruded upwards;
a plurality of conducting terminals, located in the conducting area and used for contacting the chip module; and
a separation plate, located above the conducting area and positioned by the positioning block,
wherein when the chip module is mounted downward into the insulation body, the chip module is located on the separation plate.

2. The electrical connector assembly according to claim 1, wherein the separation plate is an insulating film having a flat plate shape.

3. The electrical connector assembly according to claim 1, wherein a clearance exists between the separation plate and the conducting terminals in a height direction.

4. The electrical connector assembly according to claim 1, wherein two positioning blocks are disposed at two opposite ends of the side wall to clamp the separation plate, and a support portion is disposed between the two positioning blocks on the side wall to support the separation plate.

5. The electrical connector assembly according to claim 1, wherein a height of the separation plate is less than a height of the positioning block, and the positioning block positions the chip module.

6. The electrical connector assembly according to claim 1, wherein the insulation body has at least one positioning post for positioning the chip module, and the positioning post and the positioning block are located on different sides of the conducting area.

7. The electrical connector assembly according to claim 1, wherein an operating portion extending beyond the insulation body is disposed at each of two opposite ends of the separation plate, a pre-broken portion is disposed in the middle of the separation plate, and when the two operating portions are operated from two opposite directions, the separation plate is pulled apart at the pre-broken portion and is pulled away from the insulation body from two opposite directions.

8. The electrical connector assembly according to claim 1, wherein two separation plates are disposed and are located abreast above the conducting area, and the two separation plates are each provided with an operating portion, wherein the two operating portions face different directions, so that the two separation plates are pulled away from the insulation body from two directions.

9. The electrical connector assembly according to claim 1, further comprising a stiffener surrounding a periphery of the insulation body, wherein the stiffener has a support portion, and an extension portion extending from the separation plate and beyond the insulation body is supported by the support portion.

10. The electrical connector assembly according to claim 9, wherein the support portion is lower than the side wall, the extension portion bends downward, and a clearance exists between the separation plate and the corresponding side wall in a height direction.

11. The electrical connector assembly according to claim 1, wherein the separation plate includes an operating portion extending outward beyond the insulation body and used for horizontally pulling the separation plate away from the insulation body.

12. The electrical connector assembly according to claim 11, wherein an end of the operating portion bends upward.
